(19) United States
(12) Patent Application Publication
(10) Pub. No.: US 2014/0365173 A1
(43) Pub. Date: Dec. 11, 2014

(54) Method for Acquiring Nuclide Activity with High Nuclide Identification Ability Applicable to Spectroscopy Measured from Sodium Iodide Detector

(71) Applicant: Institute of Nuclear Energy Research, Atomic Energy Council, Executive Yuan, R.O.C., Taoyuan County (TW)

(72) Inventors: Kuo-Jen Lin, Taoyuan County (TW); Mao-Chen Liu, Taoyuan County (TW); Chung-Chih Lin, Taoyuan County (TW); Jinn-Yih Wu, Taoyuan County (TW)

(73) Assignee: Institute of Nuclear Energy Research, Atomic Energy Council, Executive Yuan, R.O.C., Taoyuan County (TW)

(21) Appl. No.: 14/167,038

(22) Filed: Jan. 29, 2014

(30) Foreign Application Priority Data
Jun. 6, 2013 (TW) 102120214

(51) Int. Cl. G06F 19/00

(52) U.S. Cl. CPC G06F 19/70
USPC 702/179

(57) ABSTRACT

A method for acquiring a nuclide activity with high nuclide identification ability applicable to a spectroscopy measured from sodium iodide detector is described. In performing this, an electronic impulse signal received by the sodium iodide detector is transformed into a spectroscopy. Then, the resulting spectroscopy is analyzed in characteristics with some previous calculations. The analysis result provides an assistance in establishing a system capable of identifying a nuclide and calculating the activity of the nuclide, which not only features an excellent nuclide identification ability but also presents a fantabulous reconstruction result. Thereby the present invention may be used for establishing a system capable of qualitative nuclide identification and activity determination that can be adapted in applications of waste clearance management.

### FIELD OF THE INVENTION

The present invention is related to a method for acquiring a nuclide activity with high nuclide identification ability applicable to spectroscopy measured from sodium iodide detector. Particularly, the present invention is related to a system capable of identifying a nuclide and calculating the activity of the nuclide, which not only features an excellent nuclide identification ability but also presents a fantabulous reconstruction result. Thereby the present invention may be used for establishing a system capable of qualitative nuclide identification and activity determination that can be adapted in applications of waste clearance management.

### DESCRIPTION OF THE RELATED ART

In a general system adapted in applications of waste clearance management, in the case of a large area plastic scintillator being used as a detector, the detection efficiency is pretty high while the plastic scintillator is not capable of identifying nuclides, leading itself to have a limitation in applications. When a germanium detector is employed to identify nuclide, its cost is high and the maintenance therefore is not easy. However, the sodium iodide detector outperforms the germanium detector in detection efficiency and possesses a nuclide identification ability, although the obtained energy resolution thereof is not as good as the germanium detector. In the case of some proper mathematic operations applied onto the spectroscopy measured from the sodium iodide detector, the nuclide identification ability thereof is sufficient to be applied in the system adapted in applications of waste clearance management.

In the measurement system adapted in applications of waste clearance management, the addition of sodium iodide detector is low in price and easy to be maintained. Dissimilarly, the germanium detector requires liquid nitrogen to be used for control of constant temperature. In view of this, the sodium iodide detector is more suitable to be used in a measure system adapted in applications of waste clearance management.

Now ¹⁵²Eu is taken as a radiation source, it is measured by the sodium iodide detector and five energy peaks in the resulting spectroscopy are found, which are presented at 344 KeV, 779 KeV, 964 KeV, 1112 KeV and 1408 KeV, respectively. Since the sodium iodide detector is not high in its energy resolution and some characteristics occurring from reaction between the emitting photons and the sodium iodide detector, the resulting energy peak is seemingly “obese”. Such energy peak distribution characteristic is approximately close to the normal distribution in mathematics, as follows:

$$f ( x ) = \frac{1}{\sqrt{2 π} σ} {e}^{- \frac{{( x - μ )}^{2}}{2 {σ}^{2}}}$$

wherein α is a channel position corresponding to the energy peak, σ is a deviation of the normal distribution, x is the channel position, f(x) times a constant makes a function of the corresponding counts of photon. Since the sodium iodide detector is not high in its energy resolution, when two energy peaks adjacent very closely to each other, leading to an overlapping of the two energy peaks and thus causing a trouble in a spectroscopy analysis process.

In addition, in the spectroscopy plot, when energy peak A (formed by nuclide A) and energy peak B (formed by nuclide B) stand very close to each other, the overlapping effect makes an addition effect (i.e. A+B), forming a larger energy peak. This larger energy peak cannot be identified as being formed by energy peak A or energy peak B by using the system measurement. The nuclide identification is determined by the channel position of the energy peak. This manner cannot determine which one between energy A and energy B dominantly forms the larger energy peak. At this time, the two energy peaks A and B are determined as only formed by one single nuclide, causing an erroneous identification.

In addition, an activity of a nuclide is obtained by deducing first a net energy peak area by using the formula:

activity=net energy peak area/(photon yield rate*detection efficiency*detection period),

wherein the photon yield rate is a constant and related to the nuclide, and the detection efficiency can be deduced In a calibration process.

When two adjacent energy peaks overlap each other, a large error may be caused to the activity by using the conventional net energy peak area calculation method according to the above formula.

In view of the drawbacks mentioned above, the inventors of the present invention provide a method for acquiring an activity with a high nuclide identification ability applicable to a spectroscopy measured from a sodium iodide detector after many efforts and researches to overcome the shortcoming encountered in the prior art.

### SUMMARY OF THE INVENTION

It is, therefore, an object of the present invention to provide a method of acquiring an activity with high nuclide identification and reconstruction ability of a nuclide applicable to a spectroscopy measured from sodium iodide detector, thereby being applied onto a measurement for waste clearance management. The method comprises the steps of: Step 1: using calibration sources to perform system calibration, by first calibrating system detection efficiency and depicting spectroscopy plot representing a relationship between a plurality of photon counts vs. a plurality of channel positions, the spectroscopy plot comprising a dotted normal distribution curve, a slanting line representing background spectroscopy, and a solid curve obtained by adding the slanting line and the dotted normal distribution line, marking on the spectroscopy plot from left to right, a left side boundary of ROI (Region Of Interest), a peak of dotted normal distribution curve and a right side boundary of ROI by a vertical solid line, respectively, marking each of a plurality of dots on the solid curve, the dotted normal distribution curve and the slanting line corresponding to each of the plurality of channel positions on the spectroscopy plot by a vertical dotted line, and marking a respective one of the plurality of photon counts for each of the plurality of channel positions on the solid curve, the dotted normal distribution curve and the slanting line by dots A, B, C, E, G, H, I, J and K, respectively, wherein the respective photon counts at dot A, B, C, E, G, H, I, J and K is denoted as a, b, c, e, g, h, i, j, and k, respectively; Step 2: calculating standard deviation a of the normal distribution by an interpolation method or an extrapolation method, deducing a horizontal distance r when a peak factor n is set with 0<n<1, and defining an operation area range ROI; Step 3: deducing the respective photon counts at each of the dots A, B, C, E, G, H, I, J and K, respectively, wherein a=ng+i and c=ng+k since the respective photon counts at the dot E and dot H is the respective photon counts at the dot G times a peak factor n, ng representing n times g, the dots I, J and K are located on a straight line, and the dots I and J, and the dots J and K are separated by a horizontal distance

$$r = σ \sqrt{2 Ln ( \frac{1}{n} )} ,$$

respectively, j=(i+k)/2, and b=g+(i+k)/2 with b=g+j; Step 4: deducing i=a−n(2b−a−c)/(2−2n), g=(2b−a−c)/(2−2n), k=c−n(2b−a−c)/(2−2n) from a=ng+i, c=ng+k and b=g+(i+k)/2, wherein a, b and c are a measured photon counts, respectively, n is a selected value, and i, g and k is an unknown value, respectively; and Step 5: deducing an activity of the nuclide by using a formula: a net area within ROI=a total area within ROI—a trapezoid area (i+k)r, wherein the nuclide activity is related to the net nuclide energy peak area.

In the embodiment, when the channel position is a non-integer, the corresponding measured value is approximately obtained by the interpolation method, and b=g+j is rewritten as b′=g′+j′.

In the embodiment, wherein each of the plurality of photon counts b′, g′ and j′ is corresponding to integer channel positions, respectively, wherein the dot G′ and the dot G are separated with a horizontal distance y, enabling the dotted normal distribution curve to be approximately as a normal distribution curve, such as

$$f ( x ) = \frac{s}{\sqrt{2 π} σ} {e}^{- \frac{{( x - μ )}^{2}}{2 {σ}^{2}}} ,$$

wherein σ is a given value, S is an unknown value and proportional to the nuclide activity, the photon counts at the dot G is

$$g = f ( 0 ) = \frac{s}{\sqrt{2 π} σ}$$

when μ is set to be zero for simplified description.

$${g}^{′} = f ( y ) = \frac{s}{\sqrt{2 π} σ} {e}^{- \frac{{y}^{2}}{2 {σ}^{2}}} = g {e}^{- \frac{{y}^{2}}{2 σ 2}}$$

with a presence of the horizontal distance y between the dots G and G′.

In the embodiment, wherein the dot J′ is located on the straight line connected between the dots I and K, and j′=i+(k−i)(r−y)/(2r) is deduced by the interpolation method and

$${b}^{′} = g {e}^{- \frac{{y}^{2}}{2 σ 2}} + i + \frac{( k - i ) ( r - y )}{2 r}$$

is deduced from b′=g′+j′.

In the embodiment, wherein

$$g = [ {b}^{′} - a - \frac{( c - a ) ( r - y )}{2 r} ] / ( {e}^{- \frac{{y}^{2}}{2 {σ}^{2}}} - n ) , i = a - n [ {b}^{′} - a - \frac{( c - a ) ( r - y )}{2 r} ] / ( {e}^{- \frac{{y}^{2}}{2 {σ}^{2}}} - n ) , \\ and$$

$$k = c - n [ {b}^{′} - a - \frac{( c - a ) ( r - y )}{2 r} ] / ( {e}^{- \frac{{y}^{2}}{2 {σ}^{2}}} - n )$$

are deduced from a=ng+i, c=ng+k, and

$${b}^{′} = g \times {e}^{- \frac{{y}^{2}}{2 {σ}^{2}}} + i + \frac{( k - i ) ( r - y )}{2 r} ,$$

wherein n is a peak factor, a, b′ and c are measured values and known, respectively, and each falls on the plurality of integer channel positions, respectively, and y and σ are obtained in the system calibration process, respectively, and the net area within ROI=the total area within ROI−(i+k)r, and the nuclide activity=the net area within ROI/(the photon yield rate*the detection efficiency*the detection period).

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic flowchart according to the present invention; and

FIG. 2 is a schematic spectroscopy decomposition according to the present invention.

### DESCRIPTION OF THE PREFERRED EMBODIMENTS

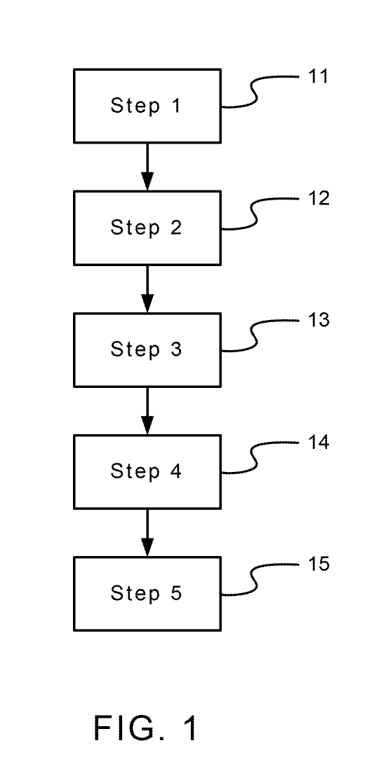

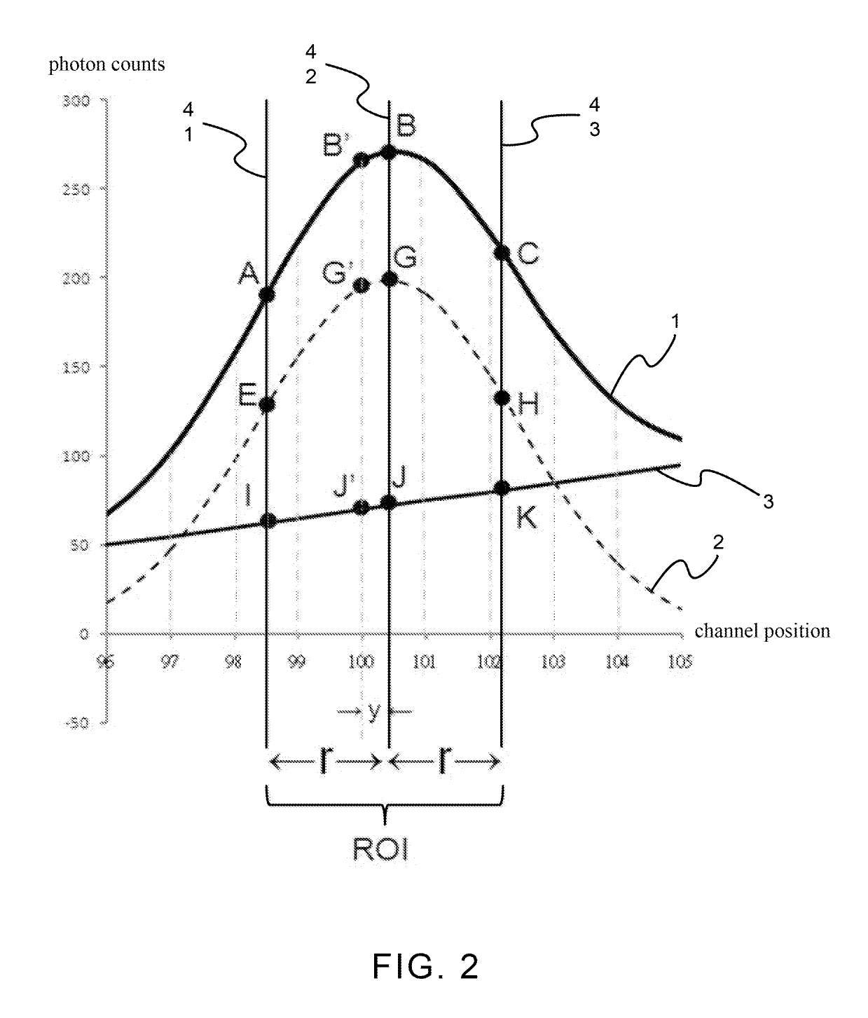

FIG. 1 and FIG. 2 is a schematic flowchart and a schematic spectroscopy decomposition according to the present invention, respectively. The method for acquiring nuclide activity with high nuclide identification ability applicable to a spectroscopy measured from sodium iodide detector according to the present invention comprises the following steps.

In Step 1, Use calibration sources to perform system calibration. A system detection efficiency is first calibrated. Then, a spectroscopy plot, with a relationship of photon counts vs. channel positions, is depicted. In the spectroscopy plot, there are a dotted normal distribution curve 2 and a slanting line 3 representing background spectroscopy, and a solid curve 1 obtained by adding the slanting line 3 and the dotted normal distribution curve 2. In the spectroscopy plot, a left side boundary of ROI 41, a peak of dotted normal distribution curve within ROI 42 and a right side boundary of ROI 43 are marked by a vertical solid line, respectively, from left to right. Further, each of a plurality of dots on the solid curve, the dotted normal distribution curve and the slanting line corresponding to each of the plurality of channel positions on the spectroscopy plot is marked by a vertical dotted line. Further, each of the plurality of channel positions is corresponding to a photon counts on the solid curve 1, the dotted normal distribution curve 2, and the slanting line 3, and the respective photon counts are marked by dots A, B, C, E, G, H, I, J and K, respectively, and the photon counts at dot A is denoted as a, and that at dot B as b, etc.

In Step 2, a standard deviation σ of the normal distribution is deduced by an interpolation method or an extrapolation method. Then, a horizontal distance r is deduced when a peak factor n is set. And an operation area range ROI(Region Of Interest) is defined.

In Step 3, deducing a=ng+i and c=ng+k from a=e+i and c=h+k since the respective photon counts at the dot E and dot H are the respective photon counts at the dot G times a peak factor n, wherein ng represents that n times g, and deducing b=g+(i+k)/2 since the dots I, J and K are located on a straight line, the dots I and J are separated by a horizontal distance

$$r = σ \sqrt{2 Ln ( \frac{1}{n} )} ,$$

the dots J and K are also separated by a horizontal distance r, and j=(i+k)/2 and b=g+j.

In Step 4, i=a−n(2b−a−c)/(2−2n), g=(2b−a−c)/(2−2n) and k=c−n(2b−a−c)/(2−2n) are deduced from a=ng+i,c=ng+k and b=g+(i+k)/2, wherein a, b and c are a measured spectroscopy value, respectively, n is a selected value, and i, g and k is an unknown value, respectively.

In Step 5, within ROI, since the environment background spectroscopy falls at the trapezoid area is (i+k)r and the ROI range is given, an area within the ROI range may be calculated by directly calculating an area of a measured spectroscopy, denoted as a total area. Then, a net nuclide energy peak area, also denoted as a to-be-measured net energy peak area, further abbreviated as a net area in this specification, i.e. the area of the dotted curve on the ROI range in FIG. 2, The net area within ROI=a total area within ROI—a trapezoid area (i+k)r. The nuclide activity=the net area within ROI/(the photon yield rate*the detection efficiency*the detection period).

The photon yield rate is a constant and related to the nuclide. The detection efficiency is obtained in a calibrating task. The detection period is given. The activity of the to-be-measured nuclide is deduced. When all to-be-measured nuclides are given, the net area corresponding to each energy peak with related to one among the all nuclides is deduced, no matter how close the adjacent energy peaks are.

In addition, the calculation for the nuclide activity is re-corrected as described follows.

In solving a=ng+i; c=ng+k and b=g+(i+k)/2, a, b and c are measured values. This may be further explained as follows.

On the spectroscopy plot, each of all the measured spectroscopy has their measured values only when the channel position is an integer. As to the measured values for those channel positions being not integer, an Interpolation method may be used to obtain an approximate value. For example with respect to FIG. 2, the channel position of dot A falls exactly between 98 and 99, the photon counts a of dot A may be obtained by the interpolation method operating on the channel positions 98 and 99 and their corresponding photon counts. Similarly, the channel position of dot C falls exactly between 102 and 103, the photon counts c of dot C may be obtained by the interpolation method operating on the channel positions 102 and 103 and their corresponding photon counts.

However, when this method is applied onto dot B, an error may cause. The channel position of dot B falls exactly between 100 and 101, the photon counts of dot B obtained by the interpolation method operating on the channel positions 100 and 101 and their corresponding photon counts, is smaller than the exact photon counts b at dot B. This is because value b is from value g, which is the maximum of the normal distribution curve, and a larger error may be caused when two photon counts at the two sides of dot G are operated by the interpolation method.

In order to solve this problem, b=g+j is rewritten as b′=g′+j′, wherein b′, g′ and j′ all corresponds to an integer channel position, respectively. Dot G′ and dot G are separated with a distance y. The dotted normal distribution curve 2 may be approximated to a normal distribution curve, as follows:

$$f ( x ) = \frac{S}{\sqrt{2 π} σ} {e}^{- \frac{{( X - μ )}^{2}}{2 {σ}^{2} }} ,$$

wherein σ is given, S is unknown and proportional to nuclide activity. For simplicity, μ is set to be 0, then dot G has the photon counts:

$$g = f ( 0 ) = \frac{S}{\sqrt{2 π} σ} .$$

Since horizontal distance y is presented between dot G′ and dot G,

$${g}^{′} = f ( y ) = \frac{S}{\sqrt{2 π} σ} {e}^{- \frac{{y}^{2}}{2 {σ}^{2}}} = g {e}^{- \frac{{y}^{2}}{2 {σ}^{2}}} .$$

Since dot J′ falls on a straight line connected between dot I and dot K, j′=i+(k−i)(r−y)/(2r) is obtained by the interpolation method. b′=g′+j′ is substituted by

$${g}^{′} = f ( y ) = \frac{S}{\sqrt{2 π} σ} {e}^{- \frac{{y}^{2}}{2 {σ}^{2}}} = g {e}^{- \frac{{y}^{2}}{2 {σ}^{2}}}$$

and j′=i+(k−i)(r−y)/(2r), b′ is obtained as follows:

$${b}^{′} = g {e}^{- \frac{{y}^{2}}{2 {σ}^{2 }}} + i + \frac{( k - i ) ( r - y )}{2 r}$$

At this time, a=ng+i, c=ng+k and

$${b}^{′} = g {e}^{- \frac{{y}^{2}}{2 {σ}^{2 }}} + i + \frac{( k - i ) ( r - y )}{2 r}$$

are combined together to deduce g, i and k, wherein n is given as a peak factor, a, b′ and c are known measured values, and corresponding to channel positions of integer, respectively. y and σ may be obtained in a system calibrating process. r may be calculated by

$$r = σ \sqrt{2 Ln ( \frac{1}{n} )} .$$

And g, i, and k are deduced as follows, respectively:

$$g = [ {b}^{′} - a - \frac{( c - a ) ( r - y )}{2 r} ] / ( {e}^{- \frac{{y}^{2}}{2 {σ}^{2}}} - n ) , \\ i = a - n [ {b}^{′} - a - \frac{( c - a ) ( r - y )}{2 r} ] / ( {e}^{- \frac{{y}^{2}}{2 {σ}^{2}}} - n ) , and$$

$$k = c - n [ {b}^{′} - a - \frac{( c - a ) ( r - y )}{2 r} ] / ( {e}^{- \frac{{y}^{2}}{2 {σ}^{2}}} - n ) .$$

The total area within ROI may be calculated by calculating an area of solid curve 1 directly, With the deduced i and k substituted into the net area within ROI=the total area within ROI−(i+k)r, the net area within ROI is obtained. And the nuclide activity may be obtained by the equation of the nuclide activity=the net area within ROI/(the photon yield rate*the detection efficiency*the detection period).

In some measurement applications, a to-be-measured article is generally given, the characteristics of the to-be-measured article are perceived. For example, in waste clearance management, a metal waste mainly comprises these nuclides ¹³⁷Cs, ⁵⁴Mn, ⁶⁰Co and ⁴⁰K, and the others each have a very small proportion and may be overlooked.

In the concrete case, ⁵⁷Co, ²¹⁴Bi, ¹³⁴Cs and ²²⁸Ac are additionally included besides the above four nuclides. Accordingly, these knowledge and the possibly formed energy peaks may be used as system settings, the net area for each of the available nuclides may be deduced by using the inventive method, no matter how close these energy peaks are to each other or how they overlap. Therefore, the nuclide identification with respect to the analysis of the spectroscopy from the sodium iodide detector according to the present invention has been optimal. In addition, the reconstruction in this invention also outperforms the prior art, since the ROI of each nuclide energy peak is fixed and will not vary as different measured results present.

In view of the above, the method for acquiring a nuclide activity applicable to a spectroscopy measured from sodium iodide detector and having high nuclide identification ability have effectively overcome the shortcomings encountered in the prior art. The electronic impulse signal received by the sodium iodide detector is transformed into a spectroscopy. Then, the resulting spectroscopy is analyzed in characteristics with some previous calculations. The analysis result provides an assistance in establishing a system capable of identifying nuclide and calculating the activity of the nuclide, which not only features an ultrahigh nuclide identification ability but also presents a fantabulous reconstruction result, thereby being applied onto a measurement for waste clearance management.

Therefore, the present invention can be deemed as more practical, improved and necessary to users, compared with the prior art.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the appended claims.

1. A method for acquiring activity of nuclide with an excellent nuclide identification ability applicable to a spectroscopy measured from sodium iodide detector, comprising the steps of:
Step 1: calibrating a given radiation source, by first calibrating system detection efficiency and depicting a spectroscopy plot representing a relationship between a plurality of photon counts vs. a plurality of channel positions, the spectroscopy plot comprising a slanting line, a dotted normal distribution curve and a solid curve obtained by adding the slanting line and the dotted normal distribution curve, marking on the spectroscopy plot from left to right, a left side boundary of ROI(Region Of Interest), a peak of the dotted normal distribution curve and a right side boundary of ROI by a vertical solid line, respectively, marking each of a plurality of dots on the solid curve, the dotted normal distribution curve and the slanting line corresponding to each of the plurality of channel positions on the spectroscopy plot by a vertical dotted line, and marking a respective one of the plurality of photon counts for each of the plurality of channel positions on the solid curve, the dotted normal distribution curve and the slanting line by dots A, B, C, E, G, H, I, J and K, respectively, wherein the respective photon counts at dot A, B, C, E, G, H, I, J and K is denoted as a, b, c, e, g, h, i, j, and k, respectively;
Step 2: calculating a standard deviation σ of the normal distribution by an interpolation method or an extrapolation method, deducing a horizontal distance r when a peak factor n is set with 0<n<1, and defining an operation area range ROI;
Step 3: deducing a=ng+i and c=ng+k from a=e+i and c=h+k since the respective photon counts at the dot E and dot H are the respective photon counts at the dot G times a peak factor n, wherein ng represents that n times g, and deducing b=g+(i+k)/2 since the dots I, J and K are located on a straight line, the dots I and J are separated by a horizontal distance
$$r = σ \sqrt{2 Ln ( \frac{1}{n} )} ,$$
the dots J and K are also separated by a horizontal distance r, and j=(i+k)/2 and b=g+j;
Step 4: deducing i=a−n(2b−a−c)/(2−2n), g=(2b−a−c)/(2−2n), k=c−n(2b−a−c)/(2−2n) from a=ng+i, c=ng+k and b=g+(i+k)/2, wherein a, b and c are a known measured value, respectively, n is a selected value (0<n<1), and i, g and k is an unknown value, respectively; and
Step 5: deducing an activity of the nuclide by using a formula: a net area within ROI=a total area within ROI—a trapezoid area (i+k)r, wherein the nuclide activity is related to the net nuclide energy peak area.

2. The method according to claim 1, wherein when the channel position is a non-integer, the corresponding measured value is approximately obtained by the interpolation method, and b=g+j is rewritten as b′=g′+j′.

3. The method according to claim 2, wherein each of the plurality of photon counts b′, g′ and j′ is corresponding to integer channel positions, respectively, wherein the dot G′ and the dot G are separated with a horizontal distance y, enabling the dotted normal distribution curve to be approximately as a normal distribution curve, such as
$$f ( x ) = \frac{S}{\sqrt{2 π} σ } {e}^{- \frac{{( X - μ )}^{2}}{2 {σ}^{2}}} ,$$
wherein a is a known value, S is an unknown value and proportional to the nuclide activity, the photon counts at the dot G is
$$g = f ( 0 ) = \frac{S}{\sqrt{2 π} σ}$$
when μ is set to be zero for simplified description.
$${g}^{′} = f ( y ) = \frac{S}{\sqrt{2 π} σ} {e}^{- \frac{{y}^{2}}{2 {σ}^{2}}} = g {e}^{- \frac{{y}^{2}}{2 {σ}^{2}}}$$
with a presence of the horizontal distance y between the dots G and G′.

4. The method according to claim 3, wherein the dot J′ is located on the straight line connected between the dots I and K, and j′=i+(k−i)(r−y)/(2r) is deduced by the interpolation method and
$${b}^{′} = g {e}^{- \frac{{y}^{2}}{2 {σ}^{2}}} + i + \frac{( k - i ) ( r - y )}{2 r}$$
is deduced.

5. The method according to claim 4, wherein
$$g = [ {b}^{′} - a - \frac{( c - a ) ( r - y )}{2 r} ] / ( {e}^{- \frac{{y}^{2}}{2 {σ}^{2}}} - n ) , \\ i = a - n [ {b}^{′} - a - \frac{( c - a ) ( r - y )}{2 r} ] / ( {e}^{- \frac{{y}^{2}}{2 {σ}^{2 }}} - n ) , and$$
$$k = c - n [ {b}^{′} - a - \frac{( c - a ) ( r - y )}{2 r} ] / ( {e}^{- \frac{{y}^{2}}{2 {σ}^{2}}} - n )$$
are deduced from a=ng+i, c=ng+k, and
$${b}^{′} = g {e}^{- \frac{{y}^{2}}{2 {σ}^{2}}} + i + \frac{( k - i ) ( r - y )}{2 r} ,$$
wherein n is a given peak factor, a, b′ and c are measured values and known, respectively, and each falls on the plurality of integer channel positions, respectively, and y and σ are obtained in the system calibration process, respectively, and the net area within ROI=the total area within ROI−(i+k)r, and the nuclide activity=the net area within ROI/(the photon yield rate*the detection efficiency*the detection period).
